(19) United States
(12) Patent Application Publication
(10) Pub. No.: US 2004/0247856 A1
(43) Pub. Date: Dec. 9, 2004

(54) Sorted composite plastic material and method for the production thereof

(76) Inventors: Gerd Sikorski, Gotha (DE); Jurgen Bruning, Werther (DE); Maik Ziegler, Grafenhain (DE); Kai Wacker, Leonberg (DE)

Correspondence Address: Norman P Soloway, Hayes Soloway, 130 W Cushing Street, Tucson, AZ, 85701, US

(21) Appl. No.: 10/489,043

(22) PCT Filed: Oct. 16, 2002
(86) PCT No.: PCT/EP02/11584

(30) Foreign Application Priority Data
Oct. 17, 2001 (DE) 101 50 678.3

(51) Int. Cl. B32B 3/26; B32B 5/18; B32B 5/24

(52) U.S. Cl. 428/318.4; 428/318.6; 442/221; 442/224; 442/315; 442/370; 442/373

(57) ABSTRACT

In order to facilitate the recycling of plastic composite materials and moldings produced thereof, the invention relates to a single-sort, mono-material composite material, comprising a core of thermoplastic foam and at least one reinforcing layer made of a composite consisting of fibers or strips of the same thermoplastic material as the foam. The invention further relates to a method for producing said single-sort composite material, during which the foam made of thermoplastic material is applied onto a pre-formed reinforcing layer and is welded there to each other and to the reinforcing layer by adding heat, a composite consisting of at least two layers of fabrics, knitted fabrics or non-wovens of fibers or strips made of the same thermoplastic material as the foam being used as reinforcing layer.

Single-sort composite plastic material and method for the production thereof The invention relates to a plastic composite material made of a core with low density where layers of higher density are applied to one or both sides in order to improve the mechanical properties of the material and moldings produced thereof at a low density or to modify other surface properties. The invention further relates to a method for producing the composite material.

Composite materials of this type are produced in many different combinations and are used as flat plates or thermoformed constructional units for example in motor vehicles as roof liners, as inserts in luggage boots, as door inner claddings, as coverings for dashboards, for steering wheels or for air bag covers, as construction materials in the building sector, in returnable packages or in the furniture industry. The adaptation of the core made of particle foam and the reinforcing layer(s) to the respective purposes makes it possible to meet various demands on the mechanical, thermal or chemical properties as well as on the decoration.

Printed patent specification DE 40 30 478 C2 for example describes the production of motor vehicle parts or of inner linings for motor vehicles or airplanes, in which a thin thermally formed polyolefin film is placed in a porous tool, the space behind the film is filled up with polyolefin foam particles and these particles are welded to each other and to the film by adding hot gas or steam in order to produce a relatively robust shaped part having a low weight and a dense structured surface. However, the shaped parts resulting from this have a low stability because the placed films show only a low tensile strength and are only applied to one side of the shaped part.

A composite is known from DE-A-196 19 892, in which a core of polypropylene particle foam is reinforced by one or two layers of expanded polypropylene film, whereof a shaped body with low weight is produced. Composites of this type show only a low rigidity because the covering layers made of foam films show a low tensile strength as well.

A sandwich construction consisting of a core made of polypropylene particle foam and covering layers made of polypropylene that are reinforced by glass mats is known from DE-A-1 95 44 451. Composites of this type show a high rigidity as a result of the covering layers that are reinforced by glass fibers. Because of the glass fibers that are enveloped with polypropylene, the covering layers can be bonded to each other by heating the surfaces and subsequent pressing. But the extraneous glass fibers prevent a simple recycling of the composite.

A similar sandwich construction is known from DE-A-198 19 750 which contains a hybrid fabric made of glass fibers and polypropylene fibers as reinforcing layer. This composite does not allow a single-sort recycling either.

A composite construction plate is described in EP-A-0 993 937 which consists of a core of polypropylene particle foam and of covering layers made of natural fibers. Because of the natural fibers this composite is also not suited to a single- sort recycling.

An object of the invention is to provide a composite material and a method for the production thereof which avoid the previously described disadvantages of the known composite materials and which allow to provide a light composite consisting of a core material of low density with covering layers having improved mechanical properties, which permits a simple and complete material recycling because of a single-sort, mono-material construction.

According to the present invention, this object is achieved by a composite comprising a core of thermoplastic foam and at least one reinforcing layer made of a composite consisting of fibers and strips made of the same thermoplastic material as the foam.

Preferably, the at least one reinforcing layer consists of at least two layers of fabrics, knitted fabrics or non-wovens made of fibers or strips of the thermoplastic material, said layers being bonded to each other by heat treatment without any binder added.

Because of the resulting improvement of the mechanical properties, it is especially advantageous if the fibers or strips are extended.

Preferably, the at least one reinforcing layer is integrally joined with the core of foam, more particularly only by heat treatment or by a combined action of heat and pressure.

A preferred material for the core is a cut foam, which is made of particle foam blocks and which may be produced so as- to have very low densities and as a result allows very light weight, rigid composites. But the core of foam may also be an extruded foam film or a composite of a plurality of extruded foam films, which show a higher density as compared to the cut particle foam. It is also possible to coat several layers of foam films on each other in order to obtain thicker materials.

Advantageously, it is possible to apply a decorative film made of the same thermoplastic material as the foam onto the external surface of the at least one reinforcing layer. It is further possible to place an extruded film made of the same thermoplastic material as the foam between the reinforcing layer and the decorative film.

Preferably, the thermoplastic material is polypropylene or a copolymer of polypropylene with one or more monomers of a thermoplastic material, preferably of a thermoplastic olefin.

In the method according to the present invention for the production of the composite material the foam made of thermoplastic material is applied to a pre-formed reinforcing layer and is welded there to each other and to the reinforcing layer by adding heat, a composite consisting of at least two layers of fabrics, knitted fabrics or non-wovens made of fibers or strips made of the same thermoplastic material as the foam being used as a reinforcing layer.

Preferably, the plastic strips are cut from extended films at a width of from about 0.5 to about 5 mm. Though the fabrics or knitted fabrics produced thereof are preferably used it is also possible to use a non-woven such as a sewn web of thread layers, Malimo™-web, and the like.

For the foam as well as for the preferably extended fibers or strips polypropylene or a polypropylene copolymer with other thermoplastic, preferably olefinic monomers is preferably used as said thermoplastic material.

The composites made of a plurality of layers of fabrics or knitted fabrics made of plastic fibers or small plastic strips used for the reinforcing layers are thermally bonded under high pressures to films or plates without the addition of any binder. The reinforcing layers are given an especially high rigidity and tensile strength if the plastic fibers or the small plastic strips used are extended before the weaving or knitting thereof, whereby the polymer chain is aligned in the stretching direction. During the assembling procedure afterwards, during which a plurality of layers of the fabrics or the knitted fabrics are heated to a temperature just below the softening temperature of the plastic material and then are pressed under high pressure between rollers or plates, the temperature control is preferably carried out such that during the heat treatment the extended fibers or strips are not heated to a temperature over their entire cross-section, for that they do not shrink and so do not lose the properties they gained by stretching. By varying the number and the thickness of the individual layers of fabrics, knitted fabrics or non-wovens, the thickness of the reinforcing layer can vary from a thin film to thicker plates and can be adapted to the respective requirements on the complete composite.

The bond between the core of foam and the reinforcing layer(s) is preferably carried out by heating one or both surfaces of the parts to be connected and by subsequent pressing. The necessary heat quantity for the welding of the core of foam and the reinforcing layer(s) is preferably supplied by a heated, gaseous heat transfer medium or by radiation of heat, for example by hot gas, superheated steam, infrared radiation or flame treatment. Though not absolutely necessary, it is also possible to place a film made of the same thermoplastic material as the foam, for example also in the form of an extruded film, between the core of foam and the reinforcing layer(s) in order to improve the heat seal.

Though the bond between the core of foam and the reinforcing layer is preferably effected by direct thermal welding it is also possible to carry out the bonding for example by means of a polyolefin hotmelt adhesive, with the same thermoplastic material as the foam also being used here as said polyolefin.

Preferably the composite is subjected to a thermoforming in a three-dimensional form that corresponds to the desired shaped body, during or after the welding. The at least one pre-formed reinforcing layer is placed in the heatable form and the form cavity behind the reinforcing layer is preferably back-filled with a particle foam, whereafter the thermoforming is carried out in a manner known per se; it is possible to additionally apply a decorative film made of the same thermoplastic material as the foam to the external surface of the at least one reinforcing layer and, optionally; to place between the reinforcing layer and the decorative film an additional extruded film or foam film, which again is produced of the same thermoplastic material as the foam in order to obtain altogether a single-sort composite that as a result is simple and cost effective to recycle, or a shaped body produced thereof.

According to a preferred embodiment of the present invention, a composite made of a cut foam plate made of extruded polypropylene particle foam of a thickness of between 5 mm and 30 mm, which is available under the trade name Fawocel™, and two reinforcing layers in the form of films or plates made of thermally pressed fabrics made of extended polypropylene small strips of a thickness between 0.1 mm und 3 mm, which is available under the trade name Curv®, is produced as described hereinabove.

The composite material according to the invention can be produced as sheets and can be used in the construction of vehicles, for car bodies, in the packaging and furniture industry or else by thermoforming can be manufactured to three-dimensional shaped bodies and can be employed in many different ways. If additional decorative films for example in the form of a thermoplastic polyolefin film are applied to one or both reinforcing layers and extruded foam films are additionally disposed under the TPO films the composite offers a rigid construction combined with a soft surface having a soft touch and an appealing design and, nevertheless, as a single-sort mono-material composite, is materially able to be recycled completely. Especially in the automotive industry this a very interesting economic aspect concerning the scrapping or recycling of end-of-life vehicles.

1-16. (cancelled)

17. A composite material comprising a core of thermoplastic foam and at least one reinforcing layer made of a composite consisting of fibers or strips made of the same thermoplastic material as the foam, wherein the at least one reinforcing layer comprises at least two layers of fabrics, knitted fabrics or non-wovens of fibers or strips of said thermoplastic material, which are bonded to each other by adding heat without any binder added and in that said fibers or strips are extended.

18. The composite material according to claim 17, wherein said at least one reinforcing layer is integrally joined with the core of foam.

19. The composite material according to claim 17, wherein the core of foam is a foam cut from particle foam blocks.

20. The composite material according to claim 17, wherein the core of foam is an extruded foam film or a composite of a plurality of extruded foam films.

21. The composite material according to claim 17, wherein a decorative film made of the same thermoplastic material as the foam is applied onto an external surface of the at least one reinforcing layer.

22. The composite material according to claim 21, wherein an extruded film made of the same thermoplastic material as the foam is placed between said reinforcing layer and said decorative film.

23. The composite material according to claim 17, wherein the thermoplastic material is polypropylene or a polypropylene copolymer.

24. A method for the production of the composite material as claimed in claim 17, wherein the foam made of thermoplastic material is applied to a pre-formed reinforcing layer and is welded there to each other and to the reinforcing layer by adding heat, with a composite comprising at least two layers of fabrics, knitted fabrics or non-wovens of extended fibers or strips made of the same thermoplastic material as the foam being used as said reinforcing layer.

25. The method according to claim 24, wherein the necessary heat quantity for said welding is supplied by a heated, gaseous heat transfer medium or by radiation of heat.

26. The method according to claim 25, wherein the heat transfer medium is air or steam.

27. The method according to claim 24, wherein polypropylene or a polypropylene copolymer is used as said thermoplastic material.

28. The method according to claim 24, wherein including the step of subjecting the composite to thermoforming during or after the welding.

29. The method according to claim 28, wherein the thermoforming is carried out at a temperature just below the melting temperature of said thermoplastic material.
